(19) United States
(12) Patent Application Publication
(10) Pub. No.: US 2025/0210674 A1
(43) Pub. Date: Jun. 26, 2025

(54) JOHNSON AMBIENT HEAT ENERGY CONVERTER WITH ENHANCED POLARIZATION

(71) Applicant: Lonnie G. Johnson, Atlanta, GA (US)

(72) Inventor: Lonnie G. Johnson, Atlanta, GA (US)

(21) Appl. No.: 19/073,137

(22) Filed: Mar. 7, 2025

Related U.S. Application Data
(63) Continuation-in-part of application No. 17/893,638, filed on Aug. 23, 2022.
Application No. 17/893,638 is a continuation-in-part of application No. 16/876,212, filed on May 18, 2020, now Pat. No. 11,489,185.
(60) Provisional application No. 63/236,015, filed on Aug. 23, 2021.

(51) Int. Cl. H01M 8/04014; H01M 8/04029; H01M 8/1016; H01M 8/2465

(52) U.S. Cl. CPC H01M 8/04014; H01M 8/04029; H01M 8/1016; H01M 8/2465

(57) ABSTRACT

An ambient heat energy generator for operation with ambient heat has a working fluid solution and a working gas. The generator includes a membrane electrode assembly that is conductive of an ion constituent of the working fluid gas and has a membrane between a hydrophobic reducing electrode and a hygroscopic oxidizing electrode. The oxidizing electrode is saturated with working solution and the reducing electrode is substantially devoid of liquid working solution. The working solution concentration difference between the electrodes produces a voltage differential which generates electric power. The working gas is oxidized in one electrode with releasing a gas constituent of the working gas whereby an ion constituent of the working gas is conducted through the membrane as electrons are routed through an external load to the reducing electrode where they react with the released gas constituent to reconstitute the working gas.

### REFERENCE TO RELATED APPLICATION

This is a continuation-in-part of U.S. patent application Ser. No. 17/893,638 filed Aug. 23, 2022 and entitled “Johnson Ambient Heat Energy Converter” which claims the benefit of U.S. Provisional Patent Application No. 63/236,015 filed Aug. 23, 2021 and entitled “Johnson Ambient Heat Energy Converter” and which is a continuation-in-part of U.S. patent application Ser. No. 16/876,212 filed May 18, 2020 and entitled “Johnson Power Generator”, which are incorporated herein by reference in their entirety.

### TECHNICAL FIELD

This invention relates generally to a system for converting thermal energy to electrical energy.

### BACKGROUND OF INVENTION

It has long been a goal to develop an engine that can harvest thermal energy that is freely available in the ambient environment. Conventional thermoelectric convertors and conventional devices that operate on a thermodynamic cycle, a heat source and a heat sink are employed and occur simultaneously. They require a simultaneous temperature differential for operation. Attempts have been made to utilize thermal insulation material and a heat sink to impose the needed temperature differential. One section of the converter is thermally insulated from the environment and/or coupled to a high heat capacity material so as to delay changes in its temperature relative to temperature changes in its environment. The lag in temperature changes relative to the section that is exposed and thermally coupled to the environment creates the required temperature differential needed for the thermoelectric converter to operate. However, the need to include a heat capacity material and thermal insulation limits the practicality of such converters. Further, conversion effectiveness decreases as parasitic heat conduction through the device's structure becomes more and more overwhelming as the size of the device is reduced.

The present inventor disclosed ambient energy converters containing a mass of hygroscopic material within a housing that is in fluid communication with ion conductive membrane electrode assembly coupled to the housing to allow the passage of ionized water or water vapor through the ion conductive membrane electrode and into contact with the hygroscopic solution. The previously disclosed converters generate power driven by changes in temperature and humidity whereby moisture from ambient air transitions into and out of the hygroscopic liquid through the membrane electrode assembly to generate power as the hygroscopic material maintains thermodynamic equilibrium with ambient vapor pressure and temperature. The prior converter is limited to operating in environments where there are changes in humidity and/or temperature.

The need remained for an ambient energy converter that can generate electricity by extracting heat from the environment without the need for transients in temperature or humidity. To address this need, the present inventor disclosed an ambient energy power generator driven by a polarization differential across a proton conductive membrane. Nafion is a classic example certain materials which uptake significantly more water in contact with liquid water than it does in contact with saturated water vapor. The converter's operating principal is based on the Schroeder's paradox which is a well-known, but not fully understood, phenomenon. The paradox exists in many polymers and gels. Essentially, the uptake of solvent in the polymer depends on the interaction with the boundary phase. See: Hydration of Ionomers and Schroeder's Paradox in Nafion, Viatcheslav Freger, J. Phys. Chem. B 2009, 113, 24-36.

The phenomenon occurs because the interface controls the water uptake (even in bulk membranes). In addition, interactions with solid materials show similar impact on water uptake depending on whether they are hydrophilic or hydrophobic. The asymmetric character of the Nafion membrane's affinity for liquid water vs. water vapor can create a diode like polarization effect. The observations are consistent with Half-Cell Ion Concentration Polarization on Nafion-Coated Electrode by Rhokyun Kwak J. Phys. Chem. Lett. 2018, 9, 2991-2999. Kwak observed unique diode like current rectification by Nafion coated electrodes.

Nafion™ was disclosed as an example membrane material having the required concentration polarization properties in contact with a proton conductive water barrier on one side to produce the desired concentration polarization effect. A proton conductive hygroscopic solution is applied to the side opposite the barrier whereby the solution maintains vapor pressure equilibrium with the surrounding air while at the same time maintaining high tension for liquid water across the barrier. However, it displayed limited in output voltage and thereby power density. Thus, the need remains for a power source that can extract energy from the ambient environment at improved power density.

Thus, the need remains for an ambient energy converter that can generate electricity by extracting heat from the environment without the need for transients in temperature or humidity. It is towards this need that the present invention is directed.

### BRIEF SUMMARY OF THE INVENTION

A heat to electric energy converter comprises a working fluid gas, a working fluid solution wherein the working fluid solution has an absorption affinity for and containing a portion of the working fluid gas, and a hydrophobic working gas reducing electrode and a hygroscopic working gas oxidizing electrode. The working fluid solution is dispersed within the reducing electrode and the oxidizing electrode with a lower concentration of working fluid solution in the reducing electrode relative to the oxidizing electrode. The energy converter also has an ion conductive membrane, wherein the ion conductive membrane is sandwiched between the reducing electrode and the oxidizing electrode, wherein the ion conductive membrane being ion conductive of an ion constituent of the working fluid gas, and wherein the oxidizing electrode and the reducing electrodes are fluidically coupled together by the working gas, the working fluid solution concentration difference between the reducing electrode and the oxidizing electrode producing a voltage differential therebetween.

### BRIEF DESCRIPTION OF DRAWINGS

FIG. 1 is a chart showing the water vapor pressure versus temperature for water, several proton conductive membrane formulations and 60% lithium bromide solution.

FIG. 2 is a functional diagram of an ambient heat to electric converter representative of the invention.

FIG. 3 a graph showing the hydrogen permeability of several selected metals.

FIG. 4 is a functional diagram showing a heat to electric converter using a solid metal hydrogen permeable hygroscopic solution barrier.

FIG. 5 shows a stack of cells electrically and electrochemically coupled in series within a casing.

FIG. 6 is a schematic, cross-sectional view of an ambient energy converter in a preferred form of the invention having a thin film, metal hydrogen permeable water barrier.

FIG. 7 is a schematic, cross-sectional view of an ambient energy converter in a preferred form of the invention having multiple thin film layers for low impedance.

FIG. 8 is a schematic, cross-sectional view of an ambient energy converter in another preferred form of the invention within a casing.

FIG. 9 is a schematic, cross-sectional view of an ambient energy converter in another preferred form of the invention shown as a stack of cells electrically and electrochemically coupled in series within a casing.

FIG. 10 is a schematic, cross-sectional view of an ambient energy converter in another preferred form of the invention within a casing.

FIG. 11 is a schematic, cross-sectional view of an ambient energy converter in another preferred form of the invention within a casing.

### DETAILED DESCRIPTION

The present invention's operating principal is based on the thermo-galvanic effect wherein heat is converted into electricity in an electrochemical cell where the voltage is a direct function of reactant phase and concentration differential across a proton conductive membrane. Nafion is disclosed herein as a membrane material that is representative of a range of materials that are suitable for operation of the invention. As described by Wikipedia, Nafion is a brand name for a sulfonated tetrafluoroethylene based fluoropolymer-copolymer discovered in the late 1960s by Walther Grot of the DuPont Corporation. Nafion is a brand of the Chemours company. It is the first of a class of synthetic polymers with ionic properties that are called ionomers. Nafion's unique ionic properties are a result of incorporating perfluorovinyl ether groups terminated with sulfonate groups onto a tetrafluoroethylene (PTFE) backbone. Nafion has received a considerable amount of attention as a proton conductor for proton exchange membrane (PEM) fuel cells because of its excellent thermal and mechanical stability. Nafion is highly hygroscopic.

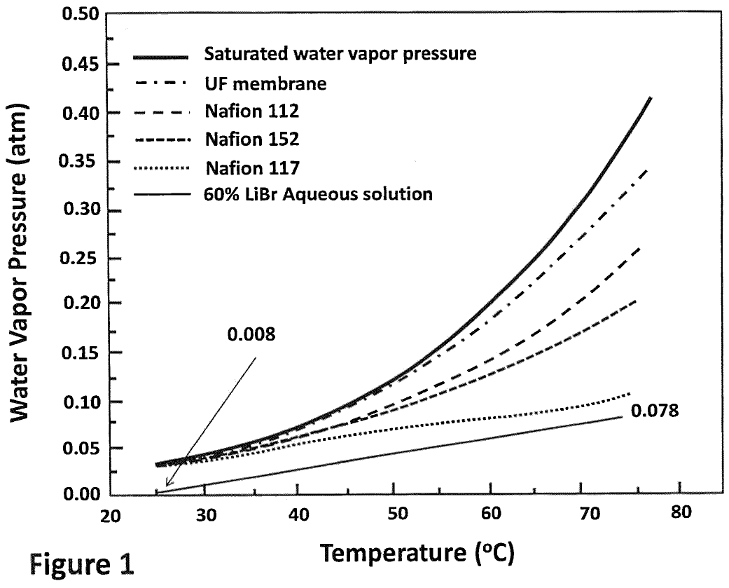

FIG. 1 shows the water vapor pressure of hydrated Nafion proton conductive membrane material and 60% weight concentrated lithium bromide (LiBr)/water solution. It should be noted that the vapor pressure of the LiBr solution is always lower than the water vapor pressure of hydrated Nafion at all temperatures. In fact, in the 30° C. to 40° C. temperature range, the vapor pressure of water contained within Nafion is very close to that of saturated water. On the other hand, Nafion's affinity for liquid water is very different. As such, the working fluid here is water.

Nafion is a classic example certain materials which uptake significantly more water in contact with liquid water than it does in contact with saturated water vapor. The converter's operating principal is based on the Schroeder's paradox which is a well-known, but not fully understood, phenomenon. The paradox exists in many polymers and gels. Essentially, the uptake of solvent in the polymer depends on the interaction with the boundary phase. See: Hydration of Ionomers and Schroeder's Paradox in Nafion, Viatcheslav Freger, J. Phys. Chem. B 2009, 113, 24-36, incorporated herein by reference in its entirety.

The phenomenon occurs because the interface controls the water uptake (even in bulk membranes). In addition, interactions with solid materials show similar impact on water uptake depending on whether they are hydrophilic or hydrophobic. The asymmetric character of the Nafion membrane's affinity for liquid water vs. water vapor can create a diode like polarization effect. The observations are consistent with Half-Cell Ion Concentration Polarization on Nafion-Coated Electrode by Rhokyun Kwak J. Phys. Chem. Lett. 2018, 9, 2991-2999. Kwak observed unique diode like current rectification by Nafion coated electrodes, incorporated herein by reference in its entirety.

At 25° C., the number of water molecules absorbed per sulfonic-acid group within Nafion is 22 in contact with liquid water whereas it is only 14 when exposed to saturated water vapor, see: Gi Suk Hwang in “Understanding Water Uptake and Transport in Nafion Using X-ray Microtomography,” pubs.acs.org/macroletters, incorporated herein by reference in its entirety.

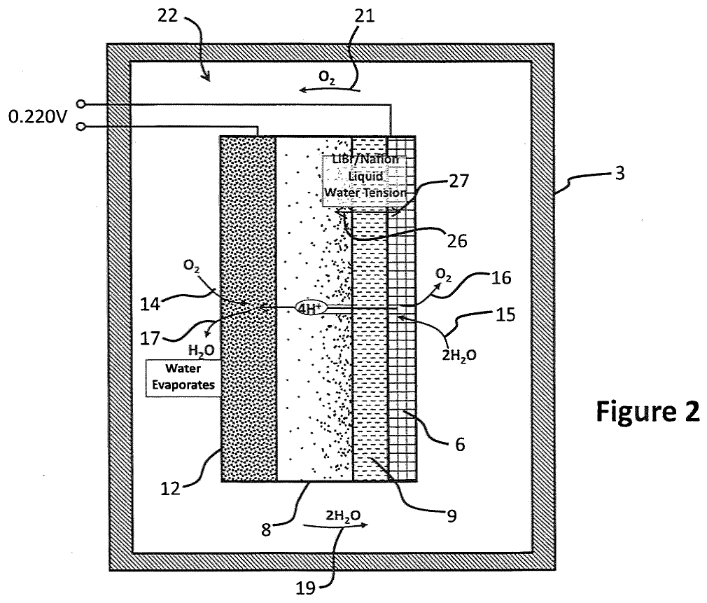

FIG. 2 shows the ambient heat energy converter 5 in a preferred basic form. The heat energy converter 5 includes first positive evaporating electrode 12 which functions as the cathode, membrane separator, separator membrane, or separator 8, porous barrier membrane 9 and second, negative condensing electrode 6 which functions as the anode all together in a layered structure. Condensing electrode 6 and evaporating electrode 12 are porous and facilitate hydrogen-oxygen reactions that electrolyze and reduce water respectively. Membrane separator 8 is made of a hygroscopic proton conductive material, such as Nafion. Barrier membrane 9 is a porous water selective membrane such as those used in reverse or forward osmosis purification of water. Porous condensing electrode 6 is hygroscopic whereas evaporating electrode 12 is hydrophobic. Porous barrier membrane 9 allows water and protons to pass through but prevents hygroscopic acid or base ions in condensing electrode 6 from passing through, only water and protons can pass.

Condensing electrode 6 may be made hygroscopic by including a hygroscopic solution such as an acid solution, preferably phosphoric acid or a base solution, preferably water and Lithium Bromide. The hydrophobic nature of evaporating electrode 12 is similar to that of conventional fuel cell cathodes designed for water to quickly evaporate as it is generated during hydrogen oxygen reactions. During operation, membrane separator's 8 high affinity for liquid water maintains a tension that pulls liquid water through porous barrier membrane 9 from condensing electrode 6 as indicated by directional arrow 26. Barrier membrane 9 does not allow ions other than water that comprise the hygroscopic material in condensing electrode 6 to pass through. Conversely, the hygroscopic nature of condensing electrode 6 maintains water tension in the opposite direction as indicated by directional arrow 27.

The basic hydrogen/oxygen/water reactions across the cell were described by Iwahara (Sintered Oxides And Its Application To Steam Electrolysis For Hydrogen Production; H. Iwahara, Solid State Ionics 3/4 (1981) 359-363), incorporated herein by reference in its entirety. He demonstrated Nerst voltage for the reaction illustrated Reaction 1 using SrCe0.95Yb0.0503-a and SrCe0.95Mg0.0503-α in a series of Proton Conduction experiments that demonstrated Nernst voltage for the water vapor concentration reaction.

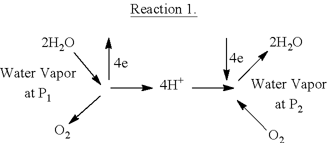

The solid oxide proton conductive material functioned as a water barrier and thereby prevented the pressures from equalizing directly by gas flow across the cell.

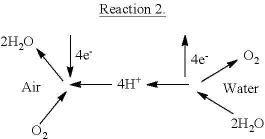

Kim demonstrated the hydrogen/oxygen/water reaction with a phase change as illustrate by Reaction 2, (Unprecedented Room-Temperature Electrical Power Generation Using Nanoscale Fluorite-Structured Oxide Electrolytes; Sangtae Kim, et. al.; Advanced Materials; DOI: 10.1002/adma.200700715), incorporated herein by reference in its entirety. Kim used nano-structured yttrium stabilized zirconia (YSZ) and nano-structured samaria-doped ceria (SDC) as proton conductive barriers. When both sides of the cells were exposed to dry air, the voltage was nearly zero. When wet air (PH2O˜1.3×10-2 bar) was introduced to one side while the other side remained exposed to dry air, the voltage increased to about-15 mV for the YSZ cell and to about −33 mV for the SDC cell. In this case the wet-air side was the anode and the dry-air side was the cathode. The dry sides of the cells were next immersed into pure (de-ionized) water while still exposing the other side of the cell to wet air. Under this condition, the water activity gradient across the electrolyte reversed (and hence the polarity of the cell) since the activity of water at the air side has become lower than at the water side. The voltage increased to reach about +180 mV and about +400 mV for the YSZ and the SDC cells, respectively. Since the nano-structured electrolytes used by Kim contained water along grain boundaries within the material, the variations in open circuit voltage could be explained by reaction potentials with the electrolytes themselves and by their water permeability. Kim was only able to achieve about 200 nA/cm2 of current with his experiments.

Operation of the present invention is driven by heat of evaporation extracted by the converter from its environment. It uses membrane separator's 8 lower affinity for water vapor relative to its affinity for liquid water. Water will preferentially evaporate from membrane separator 8 through evaporating electrode 12 as membrane separator 8 maintains high water tension at its interface with barrier membrane 9 as indicated by direction arrow 26. The hygroscopic nature of condensing electrode 6 tends to pull water in the opposite direction through barrier membrane 9 as indicated by directional arrow 27. As heat evaporates water from evaporating electrode 12, as indicated by directional arrow 17, membrane separator 8 becomes water depleted at the evaporating electrode 12 interface. This evaporation results in a concentration gradient as indicated by the dot pattern in the drawing of membrane separator 8. The concentration gradient causes membrane separator 8 to pull water through barrier membrane 9 from condensing electrode 6 in direction of arrow 26 with greater force causing condensing electrode 6 to become depleted. To maintain vapor pressure equilibrium at the condensing electrode 6 to air interface, water vapor condenses into condensing electrode 6 from the surrounding air as indicated by arrow 15. Operation of the cell is continuous as heat of evaporation is supplied by the cell's external environment.

Thus, as heat from the cell's external environment evaporates water from evaporating electrode 12, flow in one direction is achieved as Nafion pulls liquid water from its interface with water permeable barrier membrane 9. Water is reduced at evaporating electrode 12 consuming oxygen and evaporates whereas water condenses at condensing electrode 6 releasing oxygen. Operation is continuous as water vapor circulates from evaporating electrode 12 to condensing electrode 6 as indicated by directional arrows 17, 19 and 15 while oxygen circulates from condensing electrode 6 to evaporating electrode 12 as indicated by directional arrows 16, 21 and 14. As such, the water vapor and oxygen gas freely flows from one electrode to the other electrode. The term freely flows means that the gas or vapor does not have to pass through the membrane separator on this path. A relatively steady state condition of amount of water within each of the components of the cell can thus be achieved.

A voltage potential is maintained between condensing electrode 6 and evaporating electrode 12 with ionic conductivity of membrane separator 8 and the ionic conductivity of water within barrier membrane 9 providing ion conductive continuity cross the cell.

Under catalytic activity within the electrodes and the electrochemical voltage potential of the cell, water is electrolyzed at condensing electrode 6 with oxygen being released to the air inside a surrounding housing 3. The resulting protons are conducted by water through barrier membrane 9 and on through membrane separator 8 to evaporating electrode 12 as electrons are routed through an external circuit connected to circuit/terminals 22. The protons and electrons react with oxygen at evaporating electrode 12 to reproduce water. The process continues as both electrodes maintain water vapor pressure equilibrium with the air within the cell as heat evaporates water from evaporating electrode 12 and water vapor condenses into condensing electrode 6. The 1.2 volts required to electrolyze water at condensing electrode 6 is canceled by the 1.2 volts generated by the reduction of water at evaporating electrode 12. The net 220 mV representative voltage of the cell at terminals 22 is determined by the water vapor concentration differential between condensing electrode 6 and evaporating electrode 12 plus converted the energy of condensation of water entering condensing electrode 6.

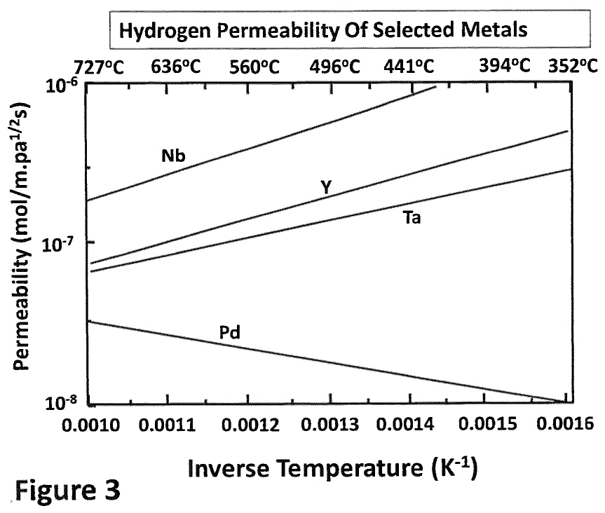

Solid barrier materials may be employed in an alternate configuration of the invention. FIG. 3 shows the hydrogen permeability of Palladium, Tantalum, Yttrium and Niobium. Palladium is a typical material used for hydrogen separation whereas Tantalum, Yttrium and Niobium are seldom used because they lose their mechanical properties in hydrogen environments due to embrittlement. The present invention does not involve the use of hydrogen as a gas; therefore, higher diffusivity material such as tantalum, Yttrium and Niobium can potentially be used.

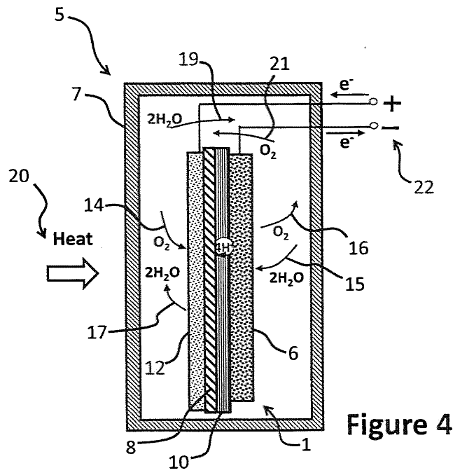

Referring now to FIG. 4, self-contained converter system 5 is shown where in converter 1 is enclosed within housing or casing 7. Hydrogen permeable solid barrier or barrier layer 10 is sandwiched between proton conductive material or membrane separator 8 and hygroscopic condensing electrode 6. Operation of the device is as previously described except barrier membrane 9 is replaced by hydrogen permeable solid barrier layer 10. Barrier layer 10 may be made of palladium, tantalum, yttrium, niobium or other suitable barrier material that has the net effect of allowing protons to pass through but not water. Barrier 10 may alternatively be a proton conductive material such as ceramic yttrium-doped barium zirconate (YBaZrO₃) or Titanium Dioxide (TiO₂), see: “Review: Recent Progress in Low-temperature Proton-conducting Ceramics”, Yuqing Meng1, J Mater Sci (2019) 54:9291-9312, incorporated herein by reference in its entirety. Given the transport properties of these materials, protons are able to move from condensing electrode 6 to evaporating electrode 12 under the electrochemical potential of the cell.

Heat of evaporation supplied by external heat source (heat) 20 is converted into electrical power under the cell's electrochemical potential. The voltage of the cell is defined by the water vapor concentration differential between condensing electrode 6 and evaporating electrode 12 plus the energy of condensation of water condensing into condensing electrode 6. Water will preferentially evaporate from evaporating electrode 12 due to its lower attraction for water vapor relative to the attraction for water vapor by condensing electrode 6. Migration of water vapor from evaporating electrode 12 to condensing electrode 6 creates a concentration gradient across membrane separator 8. As condensing electrode 6 pulls water vapor from evaporating electrode 12, a relatively steady state is maintained by conduction of protons through hydrogen permeable solid barrier layer 10 with release of oxygen from condensing electrode 6 and consumption of oxygen in evaporating electrode 12. The net effect is equivalent to movement of water from condensing electrode 6 back to evaporating electrode 12. The process continues as the reduced concentration of water within condensing electrode 6 causes it to attract and condense water to maintain vapor equilibrium with the air as indicated by arrow 15 which is, in turn, supplied by evaporating electrode 12, the water vapor pressure within housing 7 is the same for condensing electrode 6 as it is for evaporating electrode 12.

This phenomenon appears to occur because the liquid water absorption potential at the interface between membrane separator 8 and solid barrier layer 10 is higher than the water vapor absorption potential at the interface between membrane separator 8 and evaporating electrode 12 consistent with the Schroeder's paradox. Whereas hygroscopic condensing electrode 6 is able to attract water vapor from evaporating electrode 12, Nafion's higher affinity for liquid water at the barrier interface maintains a continuous process with heat of evaporation supplied to evaporating electrode 12 being converted into electrical energy.

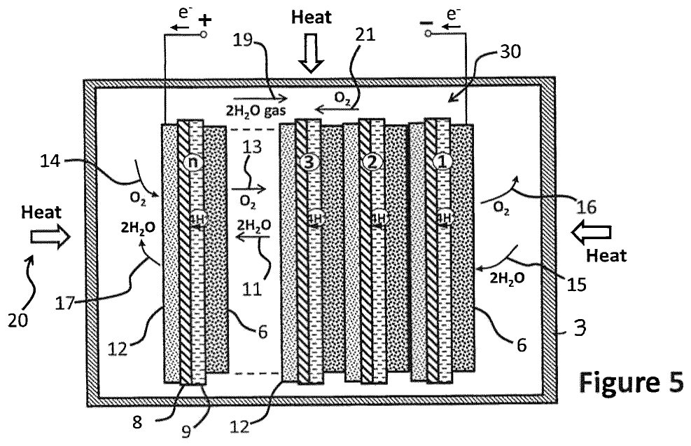

FIG. 5 shows a stack of cells “1” through “n” inside a housing or casing 3. The cells are electrically and electrochemically coupled in series. The series electrical connections achieve a cumulative overall voltage output. Water vapor 11 released from one cell's evaporating electrode 12, cathode, is absorbed by its adjacent cell's condensing electrode 6, anode. Conversely, oxygen indicated by arrow 13 is released by a condensing electrode 6, anode, as water is electrolyzed therein, is absorbed by the adjacent evaporating electrode 12, cathode, in the series to produce water. The oxidation reduction reactions that cause water migration from electrode between cells amounts to continuous pseudo circulation of water via oxidation reduction reactions as the pairing of hydrogen and oxygen atoms within any given water molecule, of course, does not necessarily remain the same atoms. Heat 20 supplied to the cell is consumed by evaporation of water from the positive electrodes (cathodes) of the cells and converted into electrical power as water condenses into the negative condensing electrode 6 (anodes). Similar to the previously described functioning of a single cell, water vapor and oxygen circulate within the housing. Water evaporates from (cathode) evaporating electrode 12 of the final cell in the stack as indicated by arrow 17, circulates around the stack as indicated by arrow 19, and condenses into the (anode) condensing electrode 6 of the first cell in the stack as indicated by directional arrow 15. Oxygen is electrolyzed out of water in condensing electrode 6 of the first cell in the stack as indicated by directional arrow 16, circulates around the stack as indicated by directional arrow 21, and enters the (cathode) evaporating electrode 12 of the final cell in the stack as indicated by directional arrow 14 where it is reduced into water which subsequently evaporates.

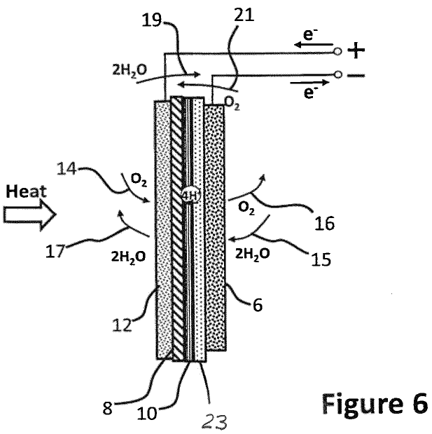

FIG. 6 shows an embodiment of the invention with hydrogen permeable solid barrier layer 10 in thin film form to lower cell impedance. Hydrogen permeable solid barrier 10 is coated onto porous substrate or separator 23. The power output of the cell is determined by a combination of electrochemical reaction kinetics within the electrodes and the proton conductive impedance across the layers of the cell. The impedance of barrier 10 is reduced by implementing it as a thin coating having thickness from 30 nanometers to 10 micrometers. Higher power density is achieved by including ion conductive, liquid or solid material, within the pores of (substrate) membrane separator 23. The combination of the ion conductive (substrate) membrane separator 23 and thin film barrier 10 results in lower overall cell impedance. The low impedance structure enables higher power density.

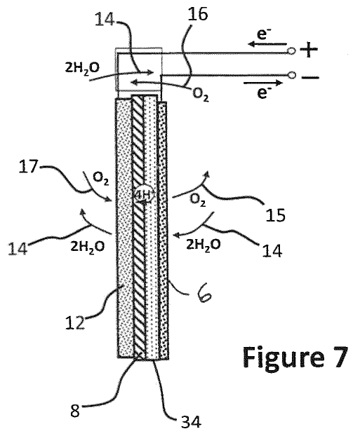

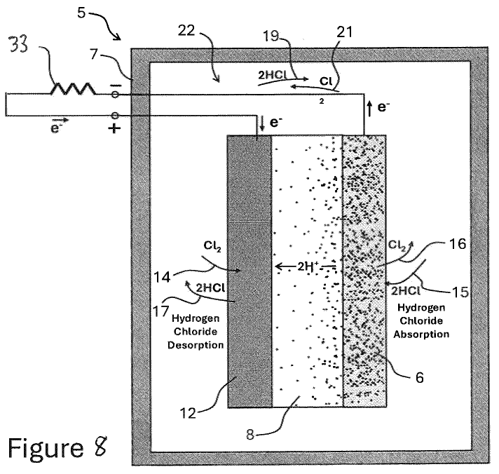

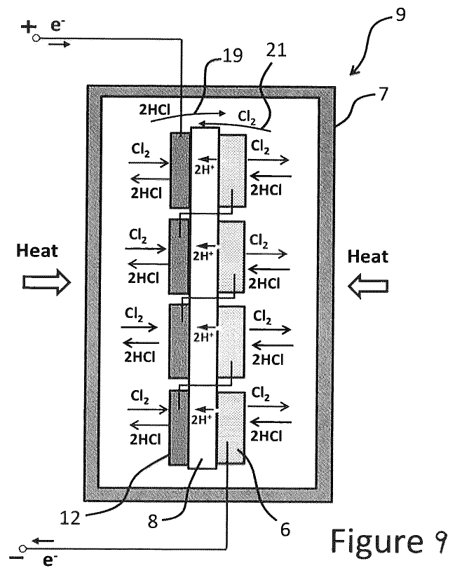

FIG. 7 illustrates an embodiment of the invention that is suitable for assembly as a thin film structure for increased power density. Negative condensing electrode 6 may be a solid electrically conductive water permeable material such as porous graphite. It may be 2.5 um to 100 μm thick or thicker. Negative condensing electrode 6 is coated with a thin layer of hygroscopic ceramic electrolyte or electrolyte layer 34. Electrolyte 34 may be 30 nm to 10 μm thick and can be applied by sputter deposition. Electrolyte 34 may be a material such as TiO2 or other proton conductive polycrystalline or nano-crystalline ceramic material. TiO2 is hygroscopic material wherein water contained along crystalline grain boundaries provides the mechanism for proton conduction. Nafion layer (membrane separator 8) functions as previously described. It may be applied as a thin coating using a liquid solvent based precursor. Layer (membrane separator 8) may be 1 to 25 μm thick. Evaporating electrode 12 a hydrophobic, electric and ion conductive coating is applied to the surface of the Nafion. It may be applied by slurry for spray coating using an evaporative solvent based precursor. The desired water tension gradient across membrane separator 8 is created by having hydrophobic water vapor evaporating electrode 12 on one side of and solid water containing hygroscopic ceramic electrolyte 34 on the other. Operation of the cell is as previously described with water being electrolyzed in condensing electrode 6 and reduced in evaporating electrode 12 under the electrochemical potential of the cell.

While not specifically shown, all embodiments may include a housing surrounding the electrode assembly.

As such, a heat to electric energy converter for operation with a working fluid being in gas and liquid phases, the electric energy converter comprises a first electrode, the first electrode being hygroscopic at a first working fluid absorption potential, a second electrode, the second electrode being hygroscopic at a working fluid absorption potential that is different from the absorption potential of the first electrode whereby a voltage potential exist between the two electrodes, an electrochemical barrier, the barrier being coupled between the first electrode and second electrode and conducting at least one ion species of the working fluid between the first electrode and the second electrode, and the first and second electrode being exposed to and coupled to each other by a gas, the gas comprising at least one constituent of the working fluid.

FIG. 8 shows the ambient heat converter 5 in a preferred basic form. The heat energy converter includes housing 7, membrane electrode assembly 22 and a deposit of hydrogen chloride acid 19 and a deposit of chlorine gas 21. Membrane electrode assembly 22 and the deposit of hydrogen chloride acid 19 and the deposit of chlorine gas 21 are hermitically contained within housing 7. Aqueous hydrogen chloride acid is soaked into condensing electrode 6 and provides a hydrogen chloride vapor/gas within housing 7. Membrane electrode assembly 22 is configured as a layered structure which includes positive evaporating electrode 12 (the anode), negative condensing electrode 6 (the anode), and membrane separator, separator membrane, or separator 8. Membrane separator 8 is comprised of a hygroscopic, proton conductive material such as Nafion. Membrane separator 8 is sandwiched between condensing electrode 6 and evaporating electrode 12. Condensing electrode 6 is formed as a composite of Nafion or other suitable hygroscopic material, a catalyst and a conductive component such as carbon. Condensing electrode 6 is saturated with aqueous hydrochloric acid. It includes a significant amount of membrane separator 8 material throughout to create a high affinity for liquid therein. The configuration provides continuous, hygroscopic liquid saturated, contact surface area between the membrane separator 8 material within condensing electrode 6 and the Nafion membrane separator 8. Evaporating electrode 12 also contains a catalyst and, in contrast to the high affinity for liquid of condensing electrode 6, positive evaporating electrode 12 is hydrophobic and thereby has a low affinity for liquid. The hydrophobic nature of evaporating electrode 12 is similar to that of conventional fuel cell cathodes designed for quick evaporation of water during hydrogen oxygen reactions. As such, evaporating electrode 12 remains relatively dry. Because of the Schroeder's phenomenon, the configuration produces in a concentration differential of hydrochloric acid (HCl) solution across membrane separator 8 which produces an electrochemical voltage differential between condensing electrode 6 and evaporating electrode 12.

During operation, the catalysts contained within condensing electrode 6 and evaporating electrode 12 facilitate hydrogen-chlorine reactions that electrolyze and reduce hydrochloric acid respectively under the voltage differential between the electrodes. With electric load 33 electrically connected between condensing electrode 6 and evaporating electrode12, hydrogen chloride is electrolyzed within condensing electrode 6 resulting in the release of chlorine gas as indicated by arrows 15 and 16 respectively. The resulting protons are conducted through membrane separator 8 and on into electrode 12 as the corresponding electrons are routed through external electric load 33 to evaporating electrode 12. At evaporating electrode 12 the electrons and protons react with chlorine gas to produce hydrogen chloride within electrode 12 as indicated by arrows 14 and 17 respectively. As indicated by arrow 21, chlorine gas released from condensing electrode 6 crosses over and enters evaporating electrode 12 as indicated by arrows 16 and 14 respectively. Similarly, as indicated by arrow 19, hydrogen chloride gas released from evaporating electrode 12 enters condensing electrode 6 as indicated by arrows 17 and 15 respectively.

The heat to electric energy converter is driven by heat input from its environment to produce electrical energy under the voltage differential produced by the hydrochloric acid concentration differential between condensing electrode 6 and evaporating electrode 12. Hydrochloric acid vapor and chlorine gas are gas phase constituents of the hydrochloric acid working fluid. Condensing electrode 6 functions as a reducing electrode wherein hydrogen chloride gas is absorbed and reduced to chlorine gas and protons. Reducing condensing electrode 6 absorbs hydrogen chloride gas and reduces it to chlorine gas which is released as the resulting electrons are supplied to external electric load 33 as the protons are conducted through membrane separator 8. On the other hand, evaporating electrode 12 is an oxidizing electrode that absorbs chlorine gas which reacts with protons and electrons therein to produce and release hydrogen chloride gas.

Condensing electrode 6, evaporating electrode 12 and membrane separator 8 contain aqueous hydrogen chloride acid as a working fluid solution. The oxidizing and reducing electrodes are exposed to and coupled to each other by hydrochloric acid working gas and chlorine working gas constituent within housing 7. Membrane separator 8 is a conductor of the hydrogen ion component of the hydrochloric acid working fluid gas. At condensing electrode 6, hydrogen is oxidized from hydrochloric acid resulting in the release of the chlorine gas constituent of the working gas. The resulting protons, ion species, are conducted through membrane separator 8 to evaporating electrode 12 as the resulting electrons are routed to evaporating electrode 12 through external electric load 9. Chlorine gas reacts with protons and electrons in reducing evaporating electrode 12 to reconstitute hydrogen chloride gas which is released within housing 7 and supplied back to the oxidizing condensing electrode 6.

FIG. 9 illustrates a configuration of the invention wherein oxidation and reducing electrode pairs 6 and 12 form an array of membrane electrode assembly cells using a single membrane separator 8. The cells in the array are electrically connected in series to provide a higher total voltage than that of a single electrode pair. The oxidizing and reducing electrode pairs are exposed to and coupled to each other by chloring gas and hydrochloric acid vapor constituents of the working fluid within housing 7. Membrane separator 8 is a conductor of the hydrogen ion component of the hydrochloric acid working fluid gas. At a given condensing electrode 6, hydrogen is oxidized from hydrochloric acid with the resulting protons, ion species, being conducted through membrane separator 8 to its counter evaporating electrode 12 of the pair as the resulting electrons are routed in series through the array of cells and external electric load 9. The protons, electrons and chlorine gas entering evaporating electrode 12 react together producing hydrogen chloride gas which is released within housing 7 and supplied back to the oxidizing condensing electrode 6.

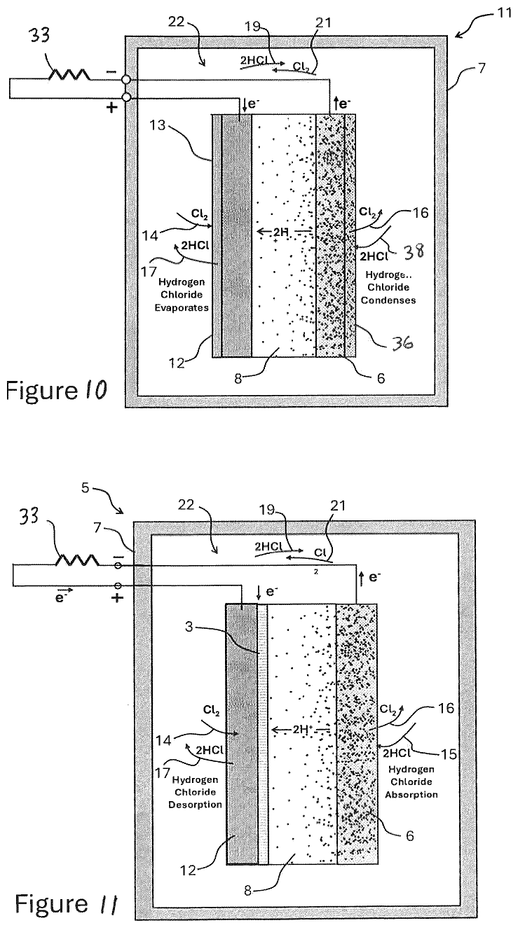

FIG. 10 illustrates the inclusion of heat management coating material layers 36 and 38 that have different emissivity/thermal radiation properties. Layer 38 has a higher emissivity than layer 36. A representative coating material 38 would be a “black coating,” typically made from materials like carbon black, which absorbs a broad spectrum of light across the visible and infrared wavelengths, making it highly efficient at absorbing heat. On the other hand, material 36 is a low emissivity material that has limited heat absorption. A representative coating material 36 would be white in color such as a low emissive white powder material or other porous material that is designed to reflect most infrared radiation. Examples include certain types of ceramic powder like white alumina, specially formulated paint pigments, or even finely milled white powders like talcum powder when applied in thick layers. The difference in heat absorptivity to emissivity between layers 36 and 38 creates a temperature differential as surface 38 absorbs more heat than it emits whereas surface 36 remains cooler as it absorbs less heat. The resulting temperature differential enhances operation of the converter as the warmer surface of evaporating electrode 12 results in a higher HCl vapor pressure therein relative to that of cooler condensing electrode 6. As such, the coatings enhance HCl evaporation from evaporating electrode 12 and condensation into condensing electrode 6 and thereby enhances heat to electric energy conversion.

FIG. 11 illustrates a configuration of the converter that includes thin, porous, hydrophobic barrier layer 3. The pores of layer 3 is porous that will naturally fill with saturated working fluid vapor with the formation of hydronium ion that will aid in the conduction of protons to reducing or evaporating electrode 12 while limiting the passage of liquid working fluid solution.

It thus is seen that an ambient energy converter is now provided which overcomes problems associated with prior art systems. While this invention has been described in detail with particular references to the preferred embodiments thereof, it should be understood that many modifications, additions and deletions, in addition to those expressly recited, may be made thereto without departure from the spirit and scope of the invention.

1. A heat to electric energy converter comprising:
a working fluid gas;
a working fluid solution, the working fluid solution having an absorption affinity for and containing a portion of the working fluid gas;
a hydrophobic working gas reducing electrode and a hygroscopic working gas oxidizing electrode, the working fluid solution dispersed within the reducing electrode and the oxidizing electrode with a lower concentration of working fluid solution in the reducing electrode relative to the oxidizing electrode, and
an ion conductive membrane, wherein the ion conductive membrane being sandwiched between the reducing electrode and the oxidizing electrode, wherein the ion conductive membrane being ion conductive of an ion constituent of the working fluid gas, and wherein the oxidizing electrode and the reducing electrodes are fluidically coupled together by the working gas, the working fluid solution concentration difference between the reducing electrode and the oxidizing electrode producing a voltage differential therebetween.

2. The heat to electric energy converter as disclosed in claim 1 wherein the ion conductive membrane comprises an ion conductive material having a different absorption affinity for working fluid in the gas phase relative to its absorption potential for working fluid in the liquid phase.

3. The heat to electric energy converter as disclosed in claim 1 wherein the oxidizing electrode is saturated with working solution and wherein the reducing electrode contains an amount of working solution less than the amount contained within the oxidizing electrode.

4. The heat to electric energy converter of claim 1 wherein the working fluid solution is a hydrogen chloride solution, and wherein the working fluid gas is a mixture of hydrogen chloride and chlorine.

5. The heat to electric energy converter of claim 1 further comprises a hydrophobic layer positioned between the ion conductive membrane and the reducing electrode.

6. The heat to electric energy converter of claim 1 further comprising a surface coating on an external surface of at least one of the reducing electrode or the oxidizing electrode to create a surface thermal emissivity differential between the reducing electrode and the oxidizing electrode.

7. The heat to electric energy converter of claim 1 wherein the ion conductive membrane is a proton conductive material.

8. The heat to electric energy converter as disclosed in claim 1 further comprising a housing containing the working fluid gas, the working fluid solution, the reducing electrode, the oxidizing electrode, and the ion conductive membrane.

9. The heat to electric energy converter as disclosed in claim 1 wherein multiple heat to electric converters are electrically connected in series to produce a higher overall output voltage.

10. The heat to electric energy converter of claim 1 wherein the ion conductive membrane is a proton conductor having barrier properties to liquid water.

11. The heat to electric energy converter of claim 4 wherein the hydrogen chloride solution is an aqueous hydrogen chloride solution.
